(19) United States
(12) Patent Application Publication
(10) Pub. No.: US 2012/0253964 A1
(43) Pub. Date: Oct. 4, 2012

(54) COMMERICAL TRANSACTION PROCESSING DEVICE, PUTTING-UP CONDITION DETERMINATION METHOD, PUTTING-UP CONDITION DETERMINATION PROGRAM AND RECORDING MEDIUM FOR STORING PROGRAM

(75) Inventor: Sadaaki Emura, Shinagawa-ku (JP)

(73) Assignee: RAKUTEN, INC., Shinagawa-ku, Tokyo (JP)

(21) Appl. No.: 13/516,383

(22) PCT Filed: Dec. 14, 2010
(86) PCT No.: PCT/JP2010/072432

§ 371 Date: Jun. 15, 2012

(30) Foreign Application Priority Data
Dec. 17, 2009 (JP) 2009-286161
Dec. 17, 2009 (JP) 2009-286162

(51) Int. Cl. G06Q 30/08

(52) U.S. Cl. 705/26.3

(57) ABSTRACT

A commercial transaction processing device stores commercial transaction information including at least one of the number of putting-up of item, the number of bids, the number of successful bids, the number of watchlist registrations and the number of user requests for an item put up for commercial transaction, per item group, receives item information of an item to reserve for commercial transaction, from a terminal device of a reserving seller of the commercial transaction, and stores the received item information as item information of the reserved item. Further, the commercial transaction processing device determines whether or not the reserved item satisfies predetermined putting-up conditions, and, when the putting-up condition determining means determines that the putting-up conditions are satisfied, executes putting-up processing of providing the item information of the reserved item as item information of a put-up item through the network.

### TECHNICAL FIELD

The present invention relates to a field of a technique of, for example, a commercial transaction processing system which can reserve an item for commercial transaction in, for example, an auction site on Internet.

### BACKGROUND ART

Recently, auctions held by auction sites on Internet are becoming familiar. A user who finished a procedure for using an auction site can access the auction site from a terminal device of the user, and put-up items or make bids in an auction.

A technique is known of, in such an auction site, making a seller reserve an item to put up from a terminal device of the seller and, when a putting-up deadline set in advance passes, automatically putting-up the reserved item. For example, Patent Literature 1 discloses a technique of automatically putting-up a reserved item when a putting-up period of the item on a magazine or a web passes in order to smoothly promote sale of an item both at a shop and in an auction (exclude the possibility of double sale of an item).

### CITATION LIST

### Patent Literature

Patent Literature 1: Japanese Patent Application Laid-Open No. 2004-139390

### SUMMARY OF INVENTION

### Technical Problem

Meanwhile, in the above auction site, a price (bidding price) of a put-up item fluctuates according to a market trend such as the number of putting-up of the same or similar item and the need of an item, and therefore a seller wishes to put up an item at an appropriate period when the price of the item is relatively high.

However, it is difficult for the seller to decide an appropriate period to put up an item. While the technique disclosed in Patent Literature 1 can automatically put up an item, this technique requires that a seller determines a putting-up period of the item, and therefore, has difficulty in flexible determination of the putting-up period due to a market trend.

In light of the above problem, an example of an object of the present invention is to provide a commercial transaction processing device, a putting-up condition determination method, a putting-up condition determination program and a recording medium for storing a program, which can automatically put up an item at an appropriate period according to a market trend.

### Solution to Problem

In order to solve the above problem, the invention according to claim 1 is a commercial transaction processing device which a terminal device can access through a network, the commercial transaction processing device comprising:

a commercial transaction information storing means that stores commercial transaction information comprising at least one of a number of putting-up of item, a number of bids, a number of successful bids, a number of watchlist registrations and a number of user requests for an item put up for commercial transaction, per item group;

an item information receiving means that receives item information of an item to reserve for commercial transaction, from a terminal device of a reserving seller of the commercial transaction;

an item information storing means that stores the received item information as item information of a reserved item;

a putting-up condition determining means that determines whether or not the reserved item satisfies a predetermined putting-up condition; and

a putting-up processing means that, when the putting-up condition determining means determines that the putting-up condition is satisfied, executes putting-up processing of providing the item information of the reserved item as item information of a put-up item through the network.

The present invention can automatically put up an item at an appropriate period according to a market trend even when a seller of an auction cannot determine a putting-up period.

The invention according to claim 2 is the commercial transaction processing device according to claim 1,

wherein the putting-up condition determining means determines whether or not at least one of a current number of putting-up of item, a current number of bids, a current number of watchlist registrations and a current number of user requests in an item group to which the reserved item belongs satisfies a predetermined putting-up condition.

The present invention can automatically put up an item at an appropriate period according to a market trend even when a seller of an auction cannot determine a putting-up period.

The invention according to claim 3 is the commercial transaction processing device according to claim 1,

further comprising a fluctuation range calculating means that calculates a fluctuation range of at least one of a number of putting-up of item, a number of bids, a number of successful bids, a number of watchlist registrations and a number of user requests in an item group to which the reserved item belongs or in an item group related to this item group, in a predetermined period,

wherein the putting-up condition determining means determines whether or not the calculated fluctuation range satisfies a predetermined putting-up condition.

The present invention can automatically put up an item at an appropriate period according to a market trend even when a seller of an auction cannot determine a putting-up period.

The invention according to claim 4 is the commercial transaction processing device according to claim 2,

wherein the item group is branched into a plurality of groups stepwise from an upper layer to a lower layer,

the item information receiving means receives item group layer information showing a layer specified by the reserving seller or an item group matching the layer, and the item information, and

the putting-up condition determining means determines whether or not at least one of a current number of putting-up of item, a current number of bids, a current number of watchlist registrations and a current number of user requests in the item group matching the layer shown in the received item group layer information satisfies a predetermined putting-up condition.

The present invention allows the reserving seller to automatically put up an item at an appropriate period matching the number of putting-up of item or the need in a range (size) of a desired item group.

The invention according to claim 5 is the commercial transaction processing device according to claim 2 or 4,

wherein the item information receiving means receives putting-up condition information showing the putting-up condition specified by the reserving seller, and the item information, and

the putting-up condition determining means determines whether or not at least one of a current number of putting-up of item, a current number of bids, a current number of watchlist registrations and a current number of user requests in an item group to which the reserved item belongs satisfies the putting-up condition shown in the received putting-up condition information.

The present invention can automatically put up an item at an appropriate period which reflects a reserving seller's intension more.

The invention according to claim 6 is the commercial transaction processing device according to any one of claims 2, 4 and 5,

wherein, when the current number of putting-up of item in the item group to which the reserved item belongs is a predetermined value or less, the putting-up condition determining means determines that the putting-up condition is satisfied.

The present invention can automatically put up an item at a timing when the number of putting-up of item in an item group to which the reserved item belongs is a little, so that the reserving seller can put up the reserved item as an item belonging to an item group of a high rarity value, at a timing when a price is relatively high.

The invention according to claim 7 is the commercial transaction processing device according to any one of claims 2, 4 and 5,

wherein, when at least one of the current number of bids, the current number of watchlist registrations and the current number of user requests in the item group to which the reserved item belongs is a predetermined value or more, the putting-up condition determining means determines that the putting-up condition is satisfied.

The present invention allows the reserving seller to put up the reserved item as an item belonging to a popular item group of a high need, at a timing when a price is relatively high.

The invention according to claim 8 is the commercial transaction processing device according to claim 3,

wherein the item group is branched into a plurality of groups stepwise from an upper layer to a lower layer,

the item information receiving means receives item group layer information showing a layer specified by the reserving seller or an item group matching the layer, and the item information, and

the fluctuation range calculating means calculates a fluctuation range of at least one of a number of putting-up of item, a number of bids, a number of successful bids, a number of watchlist registrations and a number of user requests in the item group matching the layer shown in the received item group layer information or in an item group related to the item group, in a predetermined period.

The present invention allows the reserving seller to automatically put up an item at an appropriate period matching the number of putting-up of item or the need in a range (size) of a desired item group.

The invention according to claim 9 is the commercial transaction processing device according to claim 3 or 8,

wherein the item information receiving means receives putting-up condition information showing the putting-up condition specified by the reserving seller, and the item information, and

the putting-up condition determining means determines whether or not the calculated fluctuation range satisfies the putting-up condition shown in the received putting-up condition information.

The present invention can automatically put up an item at an appropriate period which reflects a reserving seller's intension more.

The invention according to claim 10 is the commercial transaction processing device according to any one of claims 3, 8 and 9,

wherein, when the calculated fluctuation range is a predetermined value or more, the putting-up condition determining means determines that the putting-up condition is satisfied.

The present invention can automatically put up an item at an appropriate period when a fluctuation range of, for example, the need of the item group or an item group related to this item group is large.

The invention according to claim 11 is the commercial transaction processing device according to any one of claims 3, 8 and 9,

wherein, when at least one of the number of putting-up of item, the number of bids, the number of successful bids, the number of watchlist registrations and the number of user requests fluctuates in an increase direction, and the calculated fluctuation range is a predetermined value or more, the putting-up condition determining means determines that the putting-up condition is satisfied.

The invention according to claim 12 is the commercial transaction processing device according to any one of claims 3, 8 and 9,

wherein, when the number of putting-up of item fluctuates in a decrease direction, and the calculated fluctuation range is a predetermined value or more, the putting-up condition determining means determines that the putting-up condition is satisfied.

The present invention can automatically put up an item at a timing when the number of successful bids in the item group to which the reserved item belongs or in an item group related to this item group increases, so that it is possible to put up an item at a timing when a price is relatively high.

The invention according to claim 13 is a putting-up condition determination method executed by a commercial transaction processing device which a terminal device can access through a network,

the putting-up condition determination method comprising:

a step of storing commercial transaction information comprising at least one of a number of putting-up of item, a number of bids, a number of successful bids, a number of watchlist registrations and a number of user requests for an item put up for commercial transaction, per item group;

a step of receiving item information of an item to reserve for commercial transaction, from a terminal device of a reserving seller of the commercial transaction;

a step of storing the received item information as item information of a reserved item;

a step of determining whether or not the reserved item satisfies a predetermined putting-up condition; and

a step of, when determining that the putting-up condition is satisfied, executing putting-up processing of providing the item information of the reserved item as item information of a put-up item through the network.

The invention according to claim 14 is a putting-up condition determination program causing a computer included in a commercial transaction processing device which a terminal device can access through a network, to function as:

a commercial transaction information storing means that stores commercial transaction information comprising at least one of a number of putting-up of item, a number of bids, a number of successful bids, a number of watchlist registrations and a number of user requests for an item put up for commercial transaction, per item group;

an item information receiving means that receives item information of an item to reserve for commercial transaction, from a terminal device of a reserving seller of the commercial transaction;

an item information storing means that stores the received item information as item information of a reserved item;

a putting-up condition determining means that determines whether or not the reserved item satisfies a predetermined putting-up condition; and

a putting-up processing means that, when the putting-up condition determining means determines that the putting-up condition is satisfied, executes putting-up processing of providing the item information of the reserved item as item information of a put-up item through the network.

The invention according to claim 15 is a recording medium for storing a putting-up condition determination program causing a computer included in a commercial transaction processing device which a terminal device can access through a network, to function as:

a commercial transaction information storing means that stores commercial transaction information comprising at least one of a number of putting-up of item, a number of bids, a number of successful bids, a number of watchlist registrations and a number of user requests for an item put up for commercial transaction, per item group;

an item information receiving means that receives item information of an item to reserve for commercial transaction, from a terminal device of a reserving seller of the commercial transaction;

an item information storing means that stores the received item information as item information of a reserved item;

a putting-up condition determining means that determines whether or not the reserved item satisfies a predetermined putting-up condition; and

a putting-up processing means that, when the putting-up condition determining means determines that the putting-up condition is satisfied, executes putting-up processing of providing the item information of the reserved item as item information of a put-up item through the network.

### Advantageous Effects of Invention

The present invention is configured to execute putting-up processing of providing item information of a reserved item as item information of a put-up item, to a terminal device through a network when the reserved item satisfies predetermined putting-up conditions, so that, even when a seller of an auction cannot determine a putting-up period, it is possible to automatically put up the item at an appropriate period according to a market trend.

### BRIEF DESCRIPTION OF DRAWINGS

FIG. 1 is a view illustrating an example of a schematic configuration of an auction processing system S according to the present embodiment.

FIG. 2 is a block diagram illustrating an example of a schematic configuration of an auction processing server SA according to the present embodiment.

FIG. 3A to FIG. 3G are views illustrating examples of content registered in various databases.

FIG. 4 is a conceptual diagram illustrating an example of linkage of item categories registered in an item category information database 23.

FIG. 5 is a flowchart illustrating details of reserving receiving processing in a system control unit 4 of the auction processing server SA according to a first example and a second example.

FIG. 6 is a view illustrating an example of an auction reserving screen according to the first example.

FIG. 7 is a view illustrating a display example of a tree structure of item categories under putting-up conditions according to the first example and the second example.

FIG. 8 is a flowchart illustrating putting-up condition determination in the system control unit 4 of the auction processing server SA according to the first example.

FIG. 9 is a view illustrating an example of an auction reserving screen according to the second example.

FIG. 10 is a flowchart illustrating putting-up condition determination in the system control unit 4 of the auction processing server SA according to the second example.

### DESCRIPTION OF EMBODIMENTS

Hereinafter, an embodiment of the present invention will be described with reference to the drawings. In addition, the embodiment will be described below where the present invention is applied to an auction processing system.

### [1. Outline of Configuration and Function of Auction Processing System]

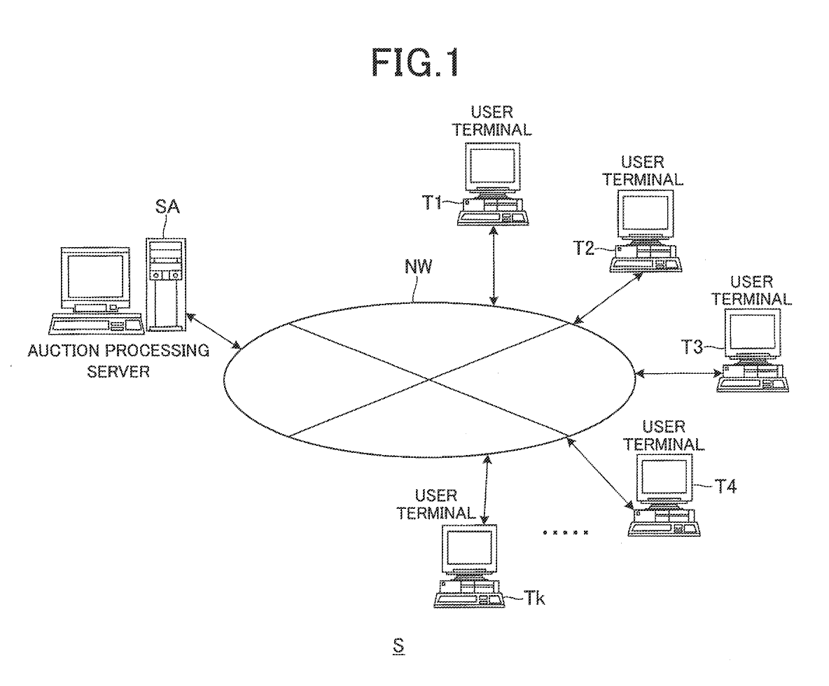

First, a configuration and a schematic function of an auction processing system S according to an embodiment of the present invention will be described using FIG. 1. FIG. 1 is a view illustrating an example of a schematic configuration of an auction processing system S according to the present embodiment.

As illustrated in FIG. 1, the auction processing system S employs a configuration including a plurality of user terminals (an example of terminal devices) Tn (n=1, 2, 3, . . . , and k), and an auction processing server (an example of a commercial transaction processing device) SA. The user terminals Tn and the auction processing server SA are each connected to a network NW. The network NW is constructed with, for example, Internet, dedicated communication lines (for example, CATV (Community Antenna Television) lines), a mobile communication network (including base stations) and a gateway. Further, the user terminals Tn are each, for example, a personal computer (PC), a PDA (Personal Digital Assistant), and a mobile telephone, and has a web browser function. The user terminals Tn each connects to the auction processing server SA by means of the web browser, acquires a web page and displays the web page on a display.

The auction processing server SA is a server (for example, a web server and a database server) installed to operate an auction site.

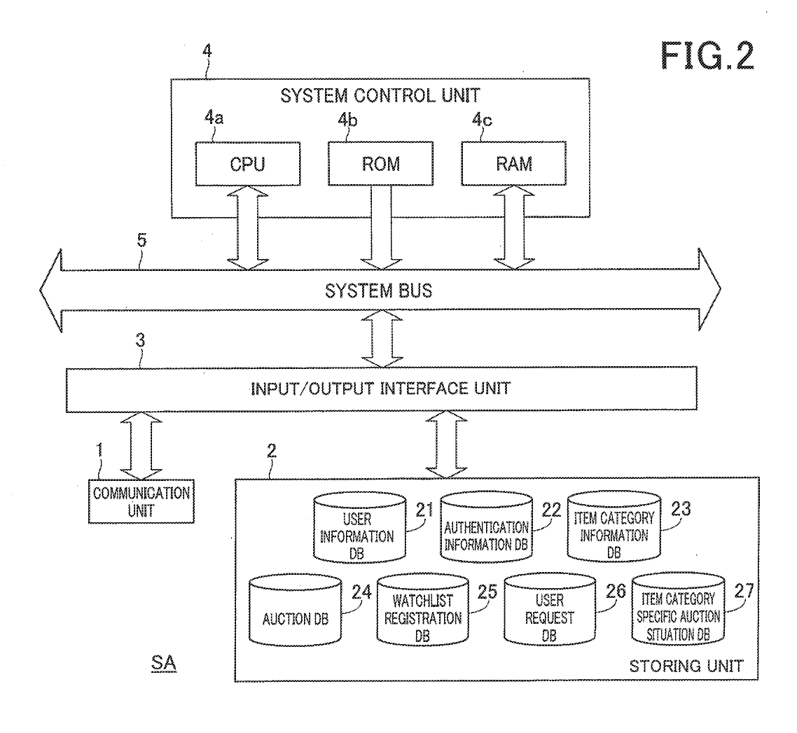

FIG. 2 is a block diagram illustrating an example of a schematic configuration of the auction processing server SA according to the present embodiment. As illustrated in FIG. 2, the auction processing server SA has a communication unit 1, a storing unit 2, an input/output interface unit 3 and a system control unit 4. Further, the system control unit 4 and the input/output interface unit 3 are connected through a system bus 5.

The communication unit 1 connects to the network NW, and controls communication states with the user terminals Tn.

The storing unit 2 employs a configuration including, for example, a hard disc drive, and stores various programs such as an operating system and an auction processing program (including a putting-up condition determination program according to the present invention). In addition, the auction processing program may be, for example, acquired through the network NW from, for example, another server device, or recorded in a recording medium and read through a drive unit.

Further, the storing unit 2 stores, for example, a structured document (for example, HTML (Hyper Text Markup Language) document or XHTML document)) file configuring a web page, and image data.

Furthermore, in the storing unit 2, a user information database (DB) 21, an authentication information database (DB) 22, an item category information database (DB) 23, an auction database (DB) 24 (an example of item information storing means), a watchlist registration database (DB) 25, a user request database (DB) 26 and an item category specific auction situation database (DB) 27 (an example of commercial transaction information storing means) are constructed.

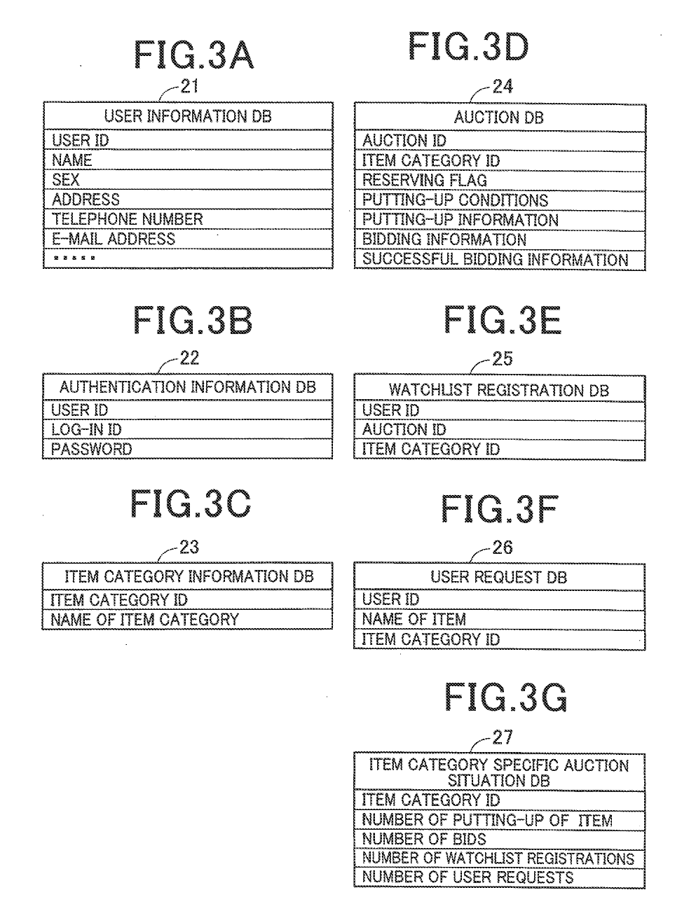

FIG. 3A to FIG. 3G are views illustrating examples of content registered in various databases.

In the user information database 21 illustrated in FIG. 3A, user information such as a user ID, a nickname, a name, the sex, an address, a telephone number and an e-mail address of a user (a user which can be a reserving seller, a seller or a bidder of an auction) registered as a member of the auction is associated per user, and is registered (stored). In addition, the user ID is identification information for identifying a user as a member.

In the authentication information database 22 illustrated in FIG. 3B, a user ID, a log-in ID and a password are associated per user, and are registered. The log-in ID and the password are authentication information used for log-in processing (authentication processing of a user) of joining (putting-up an item or making a bid) the auction.

In the item category information database 23 illustrated in FIG. 3C, an item category ID, a name of an item category and an item category ID of an item category related to this item category (hereinafter, “related item category”) are associated per item category (also referred to as “item genre”), and are registered.

Meanwhile, the item category (an example of an item group) is attribute information for classifying items of auction targets. Further, the item category is branched into a plurality of categories like a tree stepwise from an upper layer to a lower layer. Furthermore, information showing linkage (link) between item categories is also registered in the item category information database 23. In addition, the item category ID is identification information for identifying an item category.

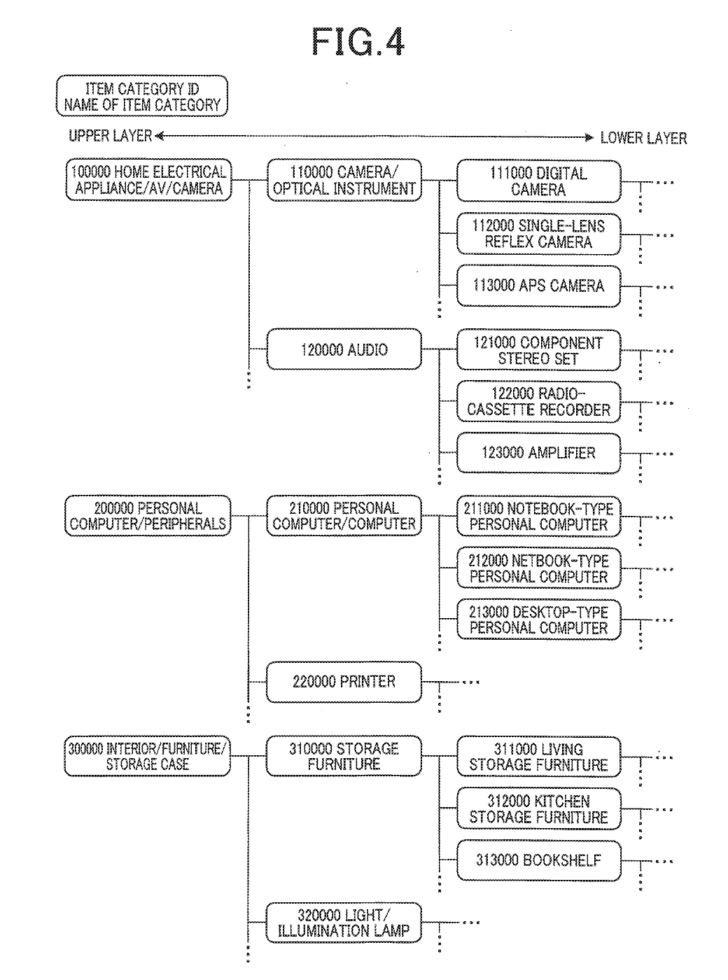

FIG. 4 is a conceptual diagram illustrating an example of linkage between item categories registered in the item category information database 23. When, for example, an item category of an item of an auction target belongs to “digital camera”, this item also belongs to “camera/optical instrument” and “home electrical appliance/AV/camera” positioned in the upper layer of “digital camera” (not belonging to, for example, “audio”). Further, with an example illustrated in FIG. 4, “digital camera” and “printer” hold the relationship of a related item category. This is because, when a digital camera is sold, a printer is likely to be sold together. Additionally, for example, “mobile telephone” and “strap” hold a relationship of a related item category.

In the auction database 24 illustrated in FIG. 3D, an auction ID, an item category ID, a reserving flag, putting-up conditions, reserving information (or putting-up information), bidding information and successful bidding information are associated per auction, and are registered. However, bidding information of items which are not yet bid and successful bidding information of items which are not yet successfully bid are not registered.

Meanwhile, the auction ID is identification information for identifying an auction of a given item. Further, an item category ID registered in the auction database 24 is an item category ID of an item category to which a reserved or put-up item belongs. For example, for this item category ID, only an item category ID of an item category in the lowermost layer to which the item belongs may be registered, and item category IDs of item categories in all layers to which the item belongs may be registered.

The reserving flag is information showing whether an item is reserved (that is, stands by) or is put up, and, for example, “1” is set when the item is reserved and “0” is set when the item is put up. Item information of a reserved item is not provided from an auction site to the user terminals Tn of users other than a reserving seller (that is, the item information is kept private), so that the reserved item cannot be bid in the auction. In addition, when putting-up conditions of a reserved item are satisfied and the item is put up, a reserving flag matching this item is changed from “1” to “0”.

The put-up conditions are conditions for putting-up a reserved item. The putting-up conditions include, for example, a, b, c and d.

[Putting-up Conditions a]: The current number of putting-up of item in an item category to which a reserved item belongs is a predetermined value or less.
[Putting-up Conditions b]: At least one of the current number of bids, the current number of watchlist registrations, the current number of user requests in an item category to which a reserved item belongs is a predetermined value or more.
[Putting-up Conditions c]: At least one of the number of put-up of item, the number of bids, the number of successful bids, the number of watchlist registrations and the number of user requests in an item category to which a reserved item belongs fluctuates in an increase direction, and a fluctuation range of at least one of the number of putting-up of item, the number of bids, the number of successful bids, the number of watchlist registrations and the number of user requests in the item category in a predetermined period is a predetermined value or more.
[Putting-up Conditions d]: The number of putting-up of item in an item category to which a reserved item belongs fluctuates in a decrease direction, and a fluctuation range of the number of putting-up of item in the item category in a predetermined period is a predetermined value or more.

Meanwhile, the number of putting-up of item, the number of bids, the number of successful bids, the number of watchlist registrations and the number of user requests are information (hereinafter, “fluctuation information”) which fluctuates from time to time according to a trend of a market such as an auction, and is used to determine whether or not putting-up conditions of a reserved item are satisfied. When this fluctuation information significantly fluctuates in the increase direction, a timing is appropriate for putting-up. In addition, also taking into account a related item category of an item category to which a reserved item belongs, putting-up conditions may include that fluctuation information in the related item category of the item category to which the reserved item belongs fluctuates in the increase direction, and a fluctuation range of fluctuation information of the related item category in this item category in a predetermined period is a predetermined value or more. This is because, when fluctuation information of a related item category (for example, printer) of an item category (for example, digital camera) to which a reserved item belongs significantly fluctuates in an increase direction, fluctuation information in the item category to which the item belongs is expected to significantly fluctuate in the increase direction in the near future.

Although the putting-up conditions d target only at the fluctuation range of the number of putting-up of item, this is because, when the number of putting-up of item significantly fluctuates in the decrease direction, the number of successful bids is great accordingly, and the need of the reserved item is expected to be greater. In addition, also taking into account a related item category of an item category to which a reserved item belongs, putting-up conditions may include that the number of putting-up of item in the related item category of the item category to which the reserved item belongs fluctuates in the decrease direction, and a fluctuation range of the number of putting-up of item in the related item category of this item category in a predetermined period is a predetermined value or more. With the putting-up conditions c and d, the number of putting-up of item applies to both of the increase direction and the decrease direction.

With the above putting-up conditions, a reserving seller can specify an item category to which a reserved item belongs (hereinafter, “an item category under putting-up conditions”), a predetermined value (hereinafter, “a predetermined value under putting-up conditions”), a predetermined period (hereinafter, “a predetermined period under putting-up conditions”) and a predetermined value (hereinafter, “a predetermined value under putting-up conditions”). In addition, putting-up conditions for an item which is put up without being reserved are not registered.

For example, a user ID of a reserving seller (or seller), a nickname of the reserving seller (or seller), a name of an item, description of the item, image data of the item, a starting price, a buy it now price, a reserve price, the number of put-up items and a putting-up period (or putting-up end date) are associated with reserving information (or putting-up information) per auction, and are registered. Meanwhile, a name of an item, description of the item, image data of the item, a starting price, a buy it now price, a reserve price and the number of put-up items, and a putting-up period (or a putting-up end date) are examples of item information of the item. In addition, for an item to be put up without being reserved, a putting-up start date specified by a seller is included in putting-up information.

Bidding information includes, for example, a user ID of a bidder, a nickname of the bidder, a bidding price, the number of bid items, and a bidding date. Successful bidding information includes, for example, a user ID of a successful bidder, a nickname of the successful bidder, a bidding price, the number of successfully bid items and a successful bidding date.

In the watchlist registration database 25 illustrated in FIG. 3E, a user ID of a user registered in an own watchlist, an auction ID of an auction registered in the watchlist, and an item category ID of an item category to which the item put up in the auction are associated per user, and are registered.

Meanwhile, the watchlist refers to a putting-up which allows a user to easily browse a trend of an auction in which the user is interested. When, for example, the user specifies a desired auction on a my auction page displayed by a web browser, and performs an operation of selecting (clicking using a mouse) a watchlist registration button, information showing, for example, an auction ID of the specified auction is transmitted to the auction processing server SA, and a user ID of the user, the auction ID and an item category ID associated with the auction ID are registered in the watchlist registration database 25 (watchlist registration). Further, when a putting-up end date of the auction registered in the watchlist by the user comes close or when an item put up in an auction which ended once is reput up, information about this is notified to the user via, for example, a my auction page or an electronic mail.

In the user request database 26 illustrated in FIG. 3F, a user ID of a user who makes a request, a name of an item which the user requested, and an item category ID of an item category to which the item belongs are associated per user, and are registered.

Meanwhile, a user request is directed to requesting an item which the user desires to be put up in an auction. When, for example, the user specifies a name of a desired item and an item category to which the item belongs, on a my auction page displayed by a web browser, and performs an operation of selecting (for example, clicking using a mouse) a user request button, information showing, for example, the specified item name is transmitted to the auction processing server SA, and a user ID of the user, the name of the item and an item category ID of an item category to which the item belongs are registered in the user request database 26. Further, when an item including the name of the item requested by the user is put up in an auction, information about this is notified to the user via, for example, a my auction page or an electronic mail. In addition, a configuration may be employed where, when an auction registered in the watchlist is not successfully bid and ends, the auction is registered in a user request to encourage the auction to be reput up.

In the item category specific auction situation database 27 illustrated in FIG. 3G, an item category ID, the current (latest) number of putting-up of item, the current number of bids, the current number of watchlist registrations and the current number of user requests are registered to be determined per item category in the lowermost layer. An item category ID registered in this database 27 is an item category ID of an item category in the lowermost layer. That is, the number of putting-up of item, the number of bids, the number of watchlist registrations and the number of user requests are counted in an item category in the lowermost layer. By registering, for example, the number of putting-up of item per item category in the lowermost layer, it is possible to calculate, for example, the number of putting-up of item in an item category in an upper layer of the lowermost layer. Meanwhile, the number of putting-up of item is updated by the system control unit 4 when, for example, the auction processing server SA receives putting-up of an item. Further, the number of bids is updated by the system control unit 4 when, for example, the auction processing server SA receives bidding of an item. Furthermore, the number of watchlist registrations is updated by the system control unit 4 upon, for example, watchlist registration. Still further, the number of user requests is updated by the system control unit 4 when, for example, the auction processing server SA receives a user request. In addition, a configuration may be employed where the number of putting-up of item, the number of bids, the number of watchlist registrations and the number of user requests are updated per predetermined time by the system control unit 4 by referring to the auction database 24, the watchlist registration database 25 and the user request database 26.

A configuration may be employed with another example where, in the category specific auction situation database 27 illustrated in FIG. 3G, an item category ID, the number putting-up of item per predetermined (for example, one hour), the number bids, the number of successful bids, the number of watchlist registrations and the number of user requests are registered to be determined per item category in the lowermost layer. In this case, for example, the number of putting-up of item per hour from past one month to the present, the number of bids, the number of successful bids, the number of watchlist registrations and the number of user requests. Also in this case, an item category ID registered in the database 27 is an item category ID of an item category in the lowermost layer. That is, the number of putting-up of item, the number of bids, the number of successful bids, the number of watchlist registrations and the number of user requests are counted in an item category in the lowermost layer. By registering, for example, the number of putting-up of item per item category in the lowermost layer, it is possible to calculate, for example, the number of putting-up of item in an item category in an upper layer of the lowermost layer. Meanwhile, the number of putting-up of item, the number of bids, the number of successful bids, the number of watchlist registrations and the number of user requests are updated (for example, added and registered) per predetermined time (for example, one hour) by, for example, the system control unit 4 by referring to the auction database 24, the watchlist registration database 25, and the user request database 26. In addition, the number of successful bids is counted from, for example, past one day to the present.

The input/output interface unit 3 performs interface processing between the communication unit 1 and the storing unit 2, and the system control unit 4.

The system control unit 4 is formed with, for example, a CPU (Central Processing Unit) 4a, a ROM (Read Only Storing) 4b and a RAM (Random Access Storing) 4c. Further, when the CPU 4a reads and executes an auction processing program stored in the storing unit 2, the system control unit 4 functions as item information receiving means, fluctuation range calculating means, putting-up condition determining means and putting-up processing means according to the present invention, and perform the following processings.

### [2. Operation of Auction Processing System]

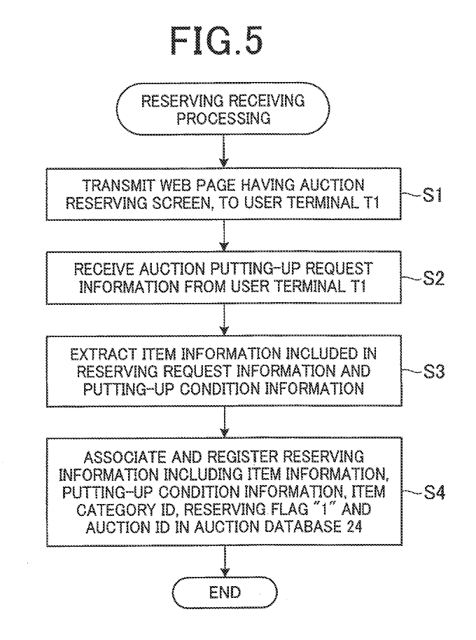

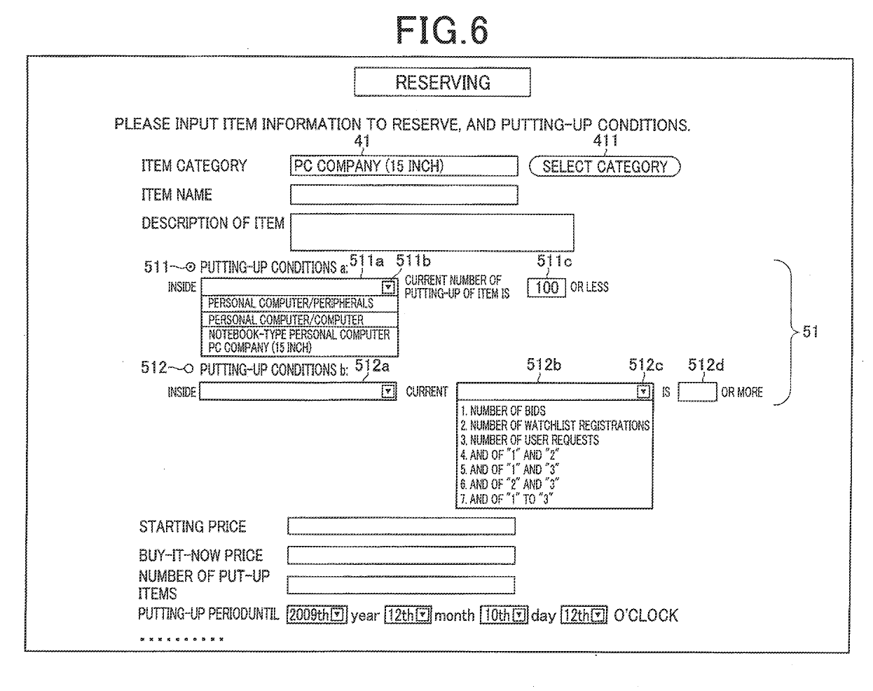

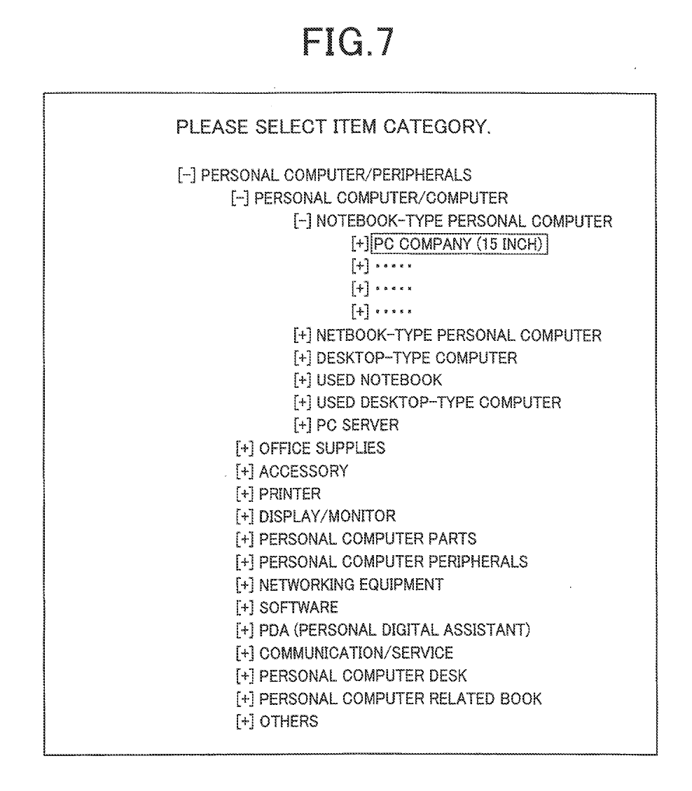

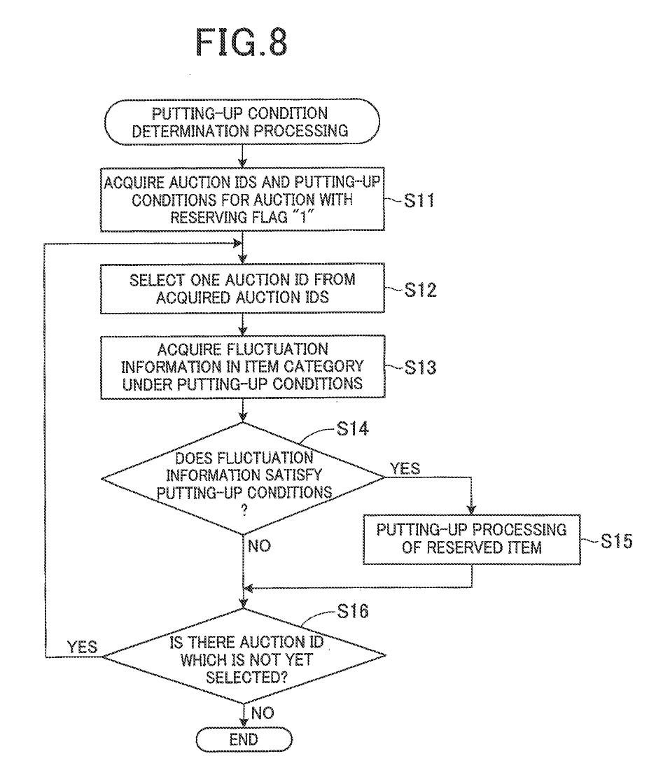

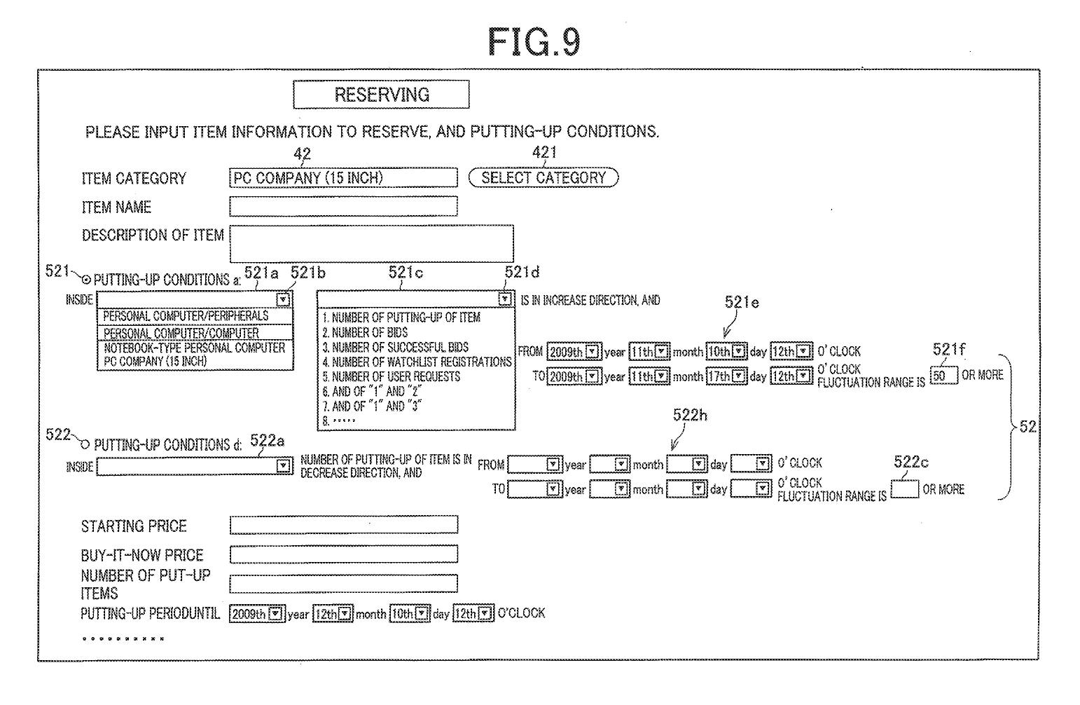

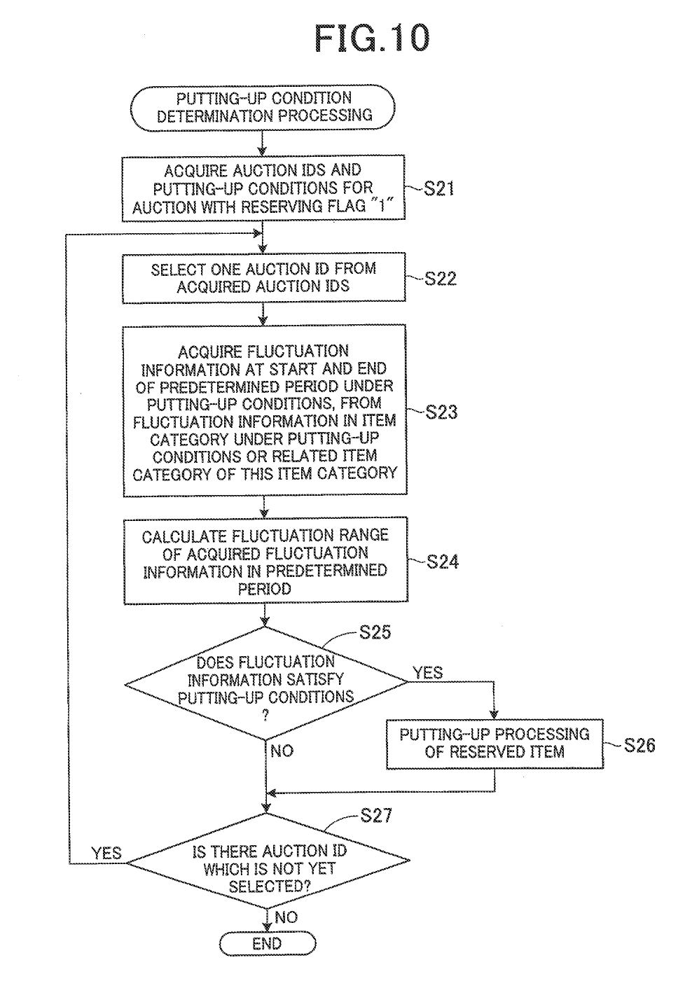

Next, an operation of the auction processing system S according to the present embodiment will be described separately in the first example and the second example using FIGS. 5 to 10. FIG. 5 is a flowchart illustrating reserving receiving processing in the system control unit 4 of the auction processing server SA according to the first example and the second example. FIG. 6 is a view illustrating an example of an auction reserving screen according to the first example. FIG. 7 is a view illustrating a display example of a tree structure of an item category under putting-up conditions according to the first example and the second example. FIG. 8 is a flowchart illustrating putting-up condition determination in the system control unit 4 of the auction processing server SA according to the first example. FIG. 9 is a view illustrating an example of an auction reserving screen according to the second example. FIG. 10 is a flowchart illustrating putting-up condition determination in the system control unit 4 of the auction processing server SA according to the second example.

### First Example

According to the first example, the auction processing server SA performs log-in processing of the user of a user terminal T1 which connects to the auction processing server SA through the network NW, then starts reserving receiving processing illustrated in FIG. 5 according to a request command of an auction reserving screen from the user terminal T1 and transmits a web page having the auction reserving screen, to the user terminal T1 (step S1).

When receiving the web page having the auction reserving screen from the auction processing server SA, the user terminal T1 displays the web page on a display by means of the web browser. With the example of the auction reserving screen illustrated in FIG. 6, specifying columns for specifying (inputting) an item category, a name of an item (item name), description of the item, a starting price, a buy it now price, the number of put-up items and a putting-up period are provided. Meanwhile, when a reserving seller operates an operation unit to select a button 411 on the right of an item category specifying column 41, a web page transitions to a page which displays a putting-up of item categories of selection candidates prepared in advance. In this page, the reserving seller can specify an item category in the lowermost layer to which an item to reserve belongs. Further, with the example of the auction reserving screen illustrated in FIG. 6, a putting-up condition specifying unit 51 is provided. The reserving seller operates the operation unit to select one of the putting-up conditions a and the putting-up conditions b using radio buttons 511 and 512 in this putting-up condition specifying unit 51.

For example, to specify the putting-up conditions a, the reserving seller needs to select the radio button 511, then specify an item category under the putting-up conditions a, in an item category specifying column 511a and specify (input) a predetermined value (for example, 100) under the putting-up conditions a, in a numerical value specifying column 511c. Meanwhile, when the reserving seller operates an operation unit to select a button 511b on the right of the item category specifying column 511a, a putting-up of item categories of selection candidates is displayed as pull-down menus to be selected as illustrated in FIG. 6. The item categories of selection candidates displayed as described above include an item category specified in the item category specifying column 41 (an item category in the lowermost layer to which a reserved items belongs), and all of item categories positioned in the upper layer of the item category. By means of the operation unit, the reserving seller can specify an item category in one of layers as an item category under the putting-up conditions a, from these item categories of the selection candidates. In addition, a configuration may be employed where, instead of a putting-up of item categories of selection candidates, a putting-up of layers of item categories of selection candidates is displayed as pull-down menus to be selected, and one of the layers is specified. For example, the layers are displayed as a lowermost layer, a second layer, a third layer and an uppermost layer.

Instead, a configuration may be employed where, when the button 511b on the right of the item category specifying column 511a is selected, a tree structure of item categories is displayed as illustrated in FIG. 7. By means of the operation unit, the reserving seller can specify an item category in one of the layers as an item category under the putting-up conditions a, from the tree structure displayed in this way.

In addition, the reserving seller may not specify an item category in the item category specifying column 511a and, in this case, an item category specified in the item category specifying column 41 is an item category specified in the item category specifying column 511a.

By contrast with this, for example, to specify the putting-up conditions b, the reserving seller needs to select the radio button 512, then specify an item category under the putting-up conditions b, in the item category specifying column 512a and specify a predetermined value under the putting-up conditions b, in the numerical value specifying column 512d, and, in addition, specify one of the number of bids, the number of watchlist registrations and the number of user requests in a fluctuation information specifying column 512b. Meanwhile, when the reserving seller operates an operation unit to select a button 512c on the right of the fluctuation information specifying column 512b, a putting-up of fluctuation information of selection candidates is displayed as pull-down menus to be selected as illustrated in FIG. 6. These selection candidates also include a combination (AND) of the number of bids, the number of watchlist registrations and the number of user requests, and, for example, a combination of the number of bids and the number of watchlist registrations can also be selected. In addition, a method of specifying an item category in the item category specifying column 512a is the same as in the item category specifying column 511a.

As described above, when the reserving seller operates the operation unit of the user terminal T1, specifies item information of an item to reserve, and putting-up conditions in each specifying column provided on the auction reserving screen, checks a confirmation screen and then performs a reserving command operation (for example, clicking the reserving button using a mouse), reserving request information for an auction is transmitted from the user terminal T1 to the auction processing server SA. In addition, reserving request information for an auction includes, for example, a user ID of a reserving seller, a nickname of the reserving seller, item information specified on the auction reserving screen and putting-up condition information showing putting-up conditions. Further, the putting-up condition information includes, for example, a layer specified by the reserving seller or item category layer information (an example of item group layer information) showing an item category matching the layer.

Furthermore, when the auction processing server SA receives putting-up request information for an auction, from the user terminal T1 (step S2), the system control unit 4 extracts item information included in the received reserving request information and putting-up condition information (step S3).

Next, the system control unit 4 associates and registers reserving information including the item information extracted in step S3, the extracted putting-up condition information, an item category ID of an item category (an item category in the lowermost layer to which an item to reserve belongs) included in the reserving information, a reserving flag “1” and an additionally numbered auction ID, in the auction database 24 (step S4). In addition, an auction ID is numbered without overlapping other auction IDs which have been already registered in the auction database 23.

Thus, the reserving seller finishes reserving an item for an auction.

Next, putting-up condition determination illustrated in FIG. 8 is started when, for example, one of the number of putting-up of item, the number of bids, the number of watchlist registrations and the number of user requests registered in the item category specific auction situation database 27 is updated. When the putting-up condition determination illustrated in FIG. 8 is started, the system control unit 4 first refers to the auction database 24, and acquires an auction ID of an auction with a reserving flag “1” and putting-up conditions associated with this auction ID, from the auction database 24 (step S11).

Next, the system control unit 4 selects one auction ID from the auction IDs acquired in step S11 (for example, selects an auction ID in order of auction IDs registered in the auction database 24) (step S12).

Next, the system control unit 4 acquires fluctuation information (at least one of the number of putting-up of item, the number of bids, the number of watchlist registrations and the number of user requests) which is shown in the putting-up conditions associated with the auction ID selected in step S12, and which is associated with an item category ID matching an item category (shown in item category layer information) under the putting-up conditions, from the item category specific auction situation database 27 (step S13).

Meanwhile, when an item category under putting-up conditions is an item category in the lowermost layer, “an item category ID matching an item category under putting-up conditions” means an item category ID of the item category. By contrast with this, when an item category under putting-up conditions is not an item category in the lowermost layer, “an item category ID matching an item category under putting-up conditions” means an item category ID of all item categories positioned in the lowermost layer of the item category. When, for example, fluctuation information shown in putting-up conditions is the number of putting-up of item, fluctuation information acquired in step S13 is a total sum of the number of putting-up of item associated with each item category ID.

Next, the system control unit 4 determines whether or not fluctuation information (that is, at least one of the current number of putting-up of item, the current number of bids, the current number of watchlist registrations and the current number of user requests inside an item category to which a reserved item belongs) acquired in step S13 satisfies the putting-up conditions associated with the auction ID selected in step S12 (an example of whether or not the reserved item satisfies the putting-up conditions) (step S14). When, for example, the current number of putting-up of item acquired in step S13 is a predetermined value or less under the putting-up conditions associated with the auction ID selected in step S12, it is determined that the putting-up conditions are satisfied. Further, when, for example, at least one of the current number of bids, the current number of watchlist registrations and the current number of user requests acquired in step S13 is a predetermined value or more under the putting-up conditions associated with the auction ID selected in step S12, it is determined that the putting-up conditions are satisfied.

Furthermore, when the system control unit 4 determines that the putting-up conditions are satisfied (step S14: YES), the step proceeds to step S15, and the system control unit 4 determines that the putting-up conditions are not satisfied (step S14: NO), the step proceeds to step S16.

In step S15, the system control unit 4 executes putting-up processing of providing item information of the reserved item matching the auction ID selected in step S12 as item information of the put-up item, to the other user terminals Tn through the network NW. With this putting-up processing, the system control unit 4 is directed to changing a reserving flag associated with the auction ID selected in step S12 from “1” to “0” and registering the reserving flag in the auction database 24, and associating and registering the current time date with the auction ID as a putting-up start date, in the auction database 24. By this means, the item information of the item associated with the auction ID can be searched for on an auction bidding screen provided to the user terminals Tn which access the auction site, so that it is possible to bid the item in the auction.

By contrast with this, in step S16, the system control unit 4 determines whether or not there is an auction ID which is not yet selected among the auction IDs acquired in step S11. Further, when the system control unit 4 determines that there is an auction ID which is not yet selected (step S16: YES), the step returns to step S12 to select an auction ID which is not yet selected and repeat the same processing as the above. By contrast with this, when the system control unit 4 determines that there is no auction ID which is not yet selected (step S16: NO), this putting-up condition determination is finished.

As described above, a configuration has been employed with the first example where, when at least one of the current number of putting-up of item, the current number of bids, the current number of watchlist registrations and the current number of user requests in an item category to which a reserved item belongs satisfies putting-up conditions matching the item, the auction processing server SA executes putting-up processing of providing item information of the reserved item as item information of the put-up item, to the user terminals Tn through the network NW, so that, even when a seller of an auction cannot determine a putting-up period, it is possible to automatically put up the item at an appropriate period according to a market trend. Further, part of elements of putting-up conditions are configured to be specified by the reserving seller, so that it is possible to automatically put up the item at an appropriate period which reflects the reserving seller's intension more. Furthermore, a layer of “an item category to which a reserved item belongs” is configured to be specified by the reserving seller at random, so that the reserving seller can automatically put up the item at an appropriate period matching the number of putting-up of item in a range (size) of a desired item category or the need.

Still further, according to a configuration of determining that putting-up conditions are satisfied when the current number of putting-up of item in an item category to which a reserved item belongs is a predetermined value or less, it is possible to automatically put up the item at a timing when the number of putting-up of item in the item category to which the reserved item is a little, so that the reserving seller can put up the reserved item as an item belonging to an item category of a high rarity value, at a timing when a price is relatively high.

Moreover, according to a configuration of determining that putting-up conditions are satisfied when at least one of the current number of bids, the current number of watchlist registrations and the current number of user requests in an item category to which a reserved item belongs is a predetermined value or less, it is possible to automatically put up the item at a timing when at least one of the number of bids, the current number of watchlist registrations and the current number of user requests in the item category to which the reserved item belongs is great, so that the reserving seller can automatically put up the reserved item as an item belonging to a popular item category of a high need, at a timing when a price is relatively high. Further, a combination of the current number of bids, the current number of watchlist registrations and the current number of user requests can be used for putting-up conditions, so that it is possible to automatically put up an item at an appropriate period which captures the need of the item more.

### Second Example

According to the second example, the auction processing server SA performs log-in processing of the user of the user terminal T1 which connects to the auction processing server SA through the network NW, then starts reserving receiving processing illustrated in FIG. 5 according to a request command of an auction reserving screen from the user terminal T1 and transmits a web page having the auction reserving screen, to the user terminal T1 (step S1).

When receiving the web page having the auction reserving screen from the auction processing server SA, the user terminal T1 displays the web page on a display by means of the web browser. With the example of the auction reserving screen illustrated in FIG. 9, specifying columns for specifying (inputting) an item category, a name of an item, description of the item, a starting price, a buy it now price, the number of put-up items and a putting-up period are provided. Meanwhile, when the reserving seller operates the operation unit to select a button 421 on the right of an item category specifying column 42, a web page transitions to a page which displays a putting-up of item categories of selection candidates prepared in advance. In this page, the reserving seller can specify an item category in the lowermost layer to which an item to reserve belongs.

Further, with the example of the auction reserving screen illustrated in FIG. 9, a putting-up condition specifying unit 52 is provided. The reserving seller operates the operation unit to select one of the putting-up conditions c and the putting-up conditions d using radio buttons 521 and 522 in this putting-up condition specifying unit 52.

For example, to specify the putting-up conditions c, the reserving seller needs to select the radio button 521, then specify an item category under the putting-up conditions c, in the item category specifying column 521a and specify at least one of the number of putting-up of item, the number of bids, the number of successful bids, the number of watchlist registrations and the number of user requests in a fluctuation information specifying column 521c. In addition, the reserving seller needs to specify a predetermined period (for example, 12 o'clock on Nov. 10, 2009 (start) to 12 o'clock on Nov. 17, 2009 (end)) under the putting-up conditions c, in a period specifying column 521e (when the current date is, for example, 12 o'clock on Nov. 18, 2009), and specify a predetermined value (for example, 50) under the putting-up conditions c in a numerical value specifying column 521f.

Meanwhile, when the reserving seller operates the operation unit to select a button 521b on the right of an item category specifying column 521a, a putting-up of item categories of selection candidates is displayed as pull-down menus to be selected as illustrated in FIG. 9. The item categories of selection candidates displayed as described above include an item category specified in the item category specifying column 42 (an item category in the lowermost layer to which a reserved items belongs), and all of item categories positioned in the upper layer of the item category. By means of the operation unit, the reserving seller can specify an item category in one of layers as an item category under the putting-up conditions c, from these item categories of the selection candidates. In addition, a configuration may be employed where, instead of a putting-up of item categories of selection candidates, a putting-up of layers of item categories of selection candidates is displayed as pull-down menus to be selected, and one of the layers is specified. For example, the layers are displayed as a lowermost layer, a second layer, a third layer and an uppermost layer.

Instead, a configuration may be employed where, when the button 521b on the right of the item category specifying column 521a is selected, a tree structure of item categories is displayed as illustrated in FIG. 7. By means of the operation unit, the reserving seller can specify an item category in one of the layers as an item category under the putting-up conditions c, from the tree structure displayed in this way.

Further, when the reserving seller operates the operation unit to select a button 521d on the right of the fluctuation information specifying column 521c, a putting-up of fluctuation information of selection candidates is displayed as pull-down menus to be selected as illustrated in FIG. 9. These selection candidates also include a combination of the number of putting-up of item, the number of bids, the number of successful bids, the number of watchlist registrations and the number of user requests, and, for example, a combination (AND) of the number of bids and the number of watchlist registrations can also be selected.

In addition, the reserving seller may not specify an item category in the item category specifying column 521a and, in this case, an item category specified in the item category specifying column 42 is an item category specified in the item category specifying column 521a.

By contrast with this, for example, to specify the putting-up conditions d, the reserving seller needs to select the radio button 522, then specify an item category under the putting-up conditions d, in an item category specifying column 522a, specify a predetermined period under the putting-up conditions d, in a period specifying column 522b and specify a predetermined value under the putting-up conditions d, in a numerical value specifying column 522c. In addition, a method of specifying these is the same as the putting-up conditions a.

As described above, when the reserving seller operates the operation unit of the user terminal T1, specifies item information of an item to reserve, and putting-up conditions in each specifying column provided on the auction reserving screen, checks a confirmation screen and then performs a reserving command operation (for example, clicking the reserving button using a mouse), reserving request information for an auction is transmitted from the user terminal T1 to the auction processing server SA. In addition, reserving request information for an auction includes, for example, a user ID of a reserving seller, a nickname of the reserving seller, item information specified on the auction reserving screen and putting-up condition information showing putting-up conditions. Further, the putting-up condition information includes, for example, a layer specified by the reserving seller or item category layer information (an example of item group layer information) showing an item category matching the layer.

Furthermore, when the auction processing server SA receives putting-up request information for an auction, from the user terminal T1 (step S2), the system control unit 4 extracts item information included in the received reserving request information and putting-up condition information (step S3).

Next, the system control unit 4 associates and registers reserving information including the item information extracted in step S3, the extracted putting-up condition information, an item category ID of an item category (an item category in the lowermost layer to which an item to reserve belongs) included in the reserving information, a reserving flag “1” and an additionally numbered auction ID, in the auction database 24 (step S4). In addition, an auction ID is numbered without overlapping other auction IDs which has been already registered in the auction database 23.

Thus, the reserving seller finishes reserving an item for an auction.

Next, putting-up condition determination illustrated in FIG. 10 is executed at, for example, a predetermined time (for example, one hour) interval. When the putting-up condition determination illustrated in FIG. 10 is started, the system control unit 4 first refers to the auction database 24, and acquires an auction ID of an auction with a reserving flag “1” and putting-up conditions associated with this auction ID, from the auction database 24 (step S21).

Next, the system control unit 4 selects one auction ID from the auction IDs acquired in step S21 (for example, select an auction ID in order of auction IDs registered in the auction database 24) (step S22).

Next, the system control unit 4 acquires fluctuation information about the start and the end of the predetermined period under the putting-up conditions, among fluctuation information (at least one of the number of putting-up of item, the number of bids, the number of successful bids, the number of watchlist registrations and the number of user requests) which is shown in the putting-up conditions associated with the auction ID selected in step S22, and which is associated with an item category ID matching an item category under the putting-up conditions or a related item category of this item category, from the item category specific auction situation database 27 (step S23).

Meanwhile, when an item category under putting-up conditions is an item category in the lowermost layer, “an item category ID matching an item category under putting-up conditions” means an item category ID of the item category. By contrast with this, when an item category under putting-up conditions is not an item category in the lowermost layer, “an item category ID matching an item category under putting-up conditions” means an item category ID of all item categories positioned in the lowermost layer of the item category (the same applies to the related item category). When, for example, fluctuation information shown in the putting-up conditions is the number of putting-up of item, fluctuation information acquired in step S23 is a total sum of the number of putting-up of item at the start and a total sum of the number of putting-up of item at the end of the predetermined period under the putting-up conditions, which are associated with each item category ID.

Next, the system control unit 4 calculates a difference Diff between fluctuation information at the start and fluctuation information at the end of the predetermined period acquired in step S23, and calculates an absolute value of the difference as a fluctuation range in this predetermined period (step S24). Meanwhile, in case of difference Diff=fluctuation information at start—fluctuation information at end, the system control unit 4 recognizes that fluctuation information fluctuates in the increase direction when the difference Diff is minus, and recognizes that fluctuation information fluctuates in the decrease direction when the difference Diff is plus.

Next, the system control unit 4 determines whether or not the fluctuation range calculated in step S24 satisfies the putting-up conditions associated with the auction ID selected in step S22 (an example of whether or not a reserved item satisfies the putting-up conditions) (step S25). When, for example, fluctuation information (at least one of the number of putting-up of item, the number of bids, the number of successful bids, the number of watchlist registrations and the number of user requests) shown in the putting-up conditions associated with the auction ID selected in step S22 fluctuates in the increase direction, and the fluctuation range calculated in step S24 is a predetermined value or more, it is determined that the putting-up conditions are satisfied. Further, when, for example, the number of putting-up of item shown in the putting-up conditions associated with the auction ID selected in step S22 fluctuates in the decrease direction, and the fluctuation range calculated in step S24 is a predetermined value or more, it is determined that the putting-up conditions are satisfied.

Furthermore, when the system control unit 4 determines that the putting-up conditions are satisfied (step S25: YES), the step proceeds to step S26, and the system control unit 4 determines that the putting-up conditions are not satisfied (step S25: NO), the step proceeds to step S27.

In step S26, the system control unit 4 executes putting-up processing of providing item information of the reserved item matching the auction ID selected in step S22 as item information of the put-up item, to the other user terminals Tn through the network NW. With this putting-up processing, the system control unit 4 is directed to changing a reserving flag associated with the auction ID selected in step S22 from “1” to “0” and registering the reserving flag in the auction database 24, and associating and registering the current time date with the auction ID as a putting-up start date, in the auction database 24. By this means, the item information of the item associated with the auction ID can be searched for on an auction bidding screen provided to the user terminals Tn which access the auction site, so that it is possible to bid the item in the auction.

By contrast with this, in step S27, the system control unit 4 determines whether or not there is an auction ID which is not yet selected among the auction IDs acquired in step S21. Further, when the system control unit 4 determines that there is an auction ID which is not yet selected (step S27: YES), the step returns to step S22 to select an auction ID which is not yet selected and repeat the same processing as the above. By contrast with this, when the system control unit 4 determines that there is no auction ID which is not yet selected (step S27: NO), this putting-up condition determination is finished.

As described above, a configuration has been employed with the second example, where, when a fluctuation range of at least one of the number of putting-up of item, the number of bids, the number of successful bids, the number of watchlist registrations and the number of user requests in an item category to which a reserved item belongs or in a related item category of this item category, in a predetermined period satisfies predetermined putting-up conditions, the auction processing server SA executes putting-up processing of providing item information of the reserved item as item information of the put-up item, to the user terminals Tn through the network NW, so that, even when a seller of an auction cannot determine a putting-up period, it is possible to automatically put up the item at an appropriate period according to a market trend. Further, part of elements of putting-up conditions are configured to be specified by the reserving seller, so that it is possible to automatically put up the item at an appropriate period which reflects the reserving seller's intension more. Furthermore, a layer of “an item category to which a reserved item belongs” is configured to be specified by the reserving seller at random, so that the reserving seller can automatically put up the item at an appropriate period matching the number of putting-up of item in a range (size) of a desired item category or the need.

Moreover, according to a configuration of determining that putting-up conditions are satisfied when at least one of the number of putting-up of item, the number of bids, the number of successful bids, the number of watchlist registrations and the number of user requests in an item category to which a reserved item belongs or in a related item category of this item category fluctuates in the increase direction, and a fluctuation range is a predetermined value or more, it is possible to automatically put up the item at a timing when the need of the item category to which the reserved item belongs or the related item category is increasing and, consequently, put up the item at a timing when the price is relatively high. Further, a combination of the number of putting-up of item, the number of bids, the number of successful bids, the number of watchlist registrations and the number of user requests can be used for the putting-up conditions, so that it is possible to automatically put up an item at an appropriate period which captures the need of the item more.

Furthermore, according to a configuration of determining that putting-up conditions are satisfied when the number of putting-up of item in an item category to which a reserved item belongs or in a related item category of this item category fluctuates in the decrease direction, and the fluctuation range is a predetermined value or more, it is possible to automatically put up the item at a timing when the number of successful bids in the item category to which the reserved item belongs or in the related item category is increasing and, consequently, put up the item at a timing when the price is relatively high.

In addition, although the putting-up conditions can be determined more effectively by adopting item categories as an example of item groups with the above embodiment, the item categories may be applied to items classified by another method.

Further, although a configuration has been employed with the above embodiment where the reserving seller can specify putting-up conditions, a configuration may be employed with another example where putting-up conditions are uniformly specified by a system administrator.

Furthermore, although an example has been described with the above embodiment where commercial transaction is, for example, an auction, the present invention is applicable to, for example, reserve an item upon buying and selling of items in a shopping site in addition to an auction.

### REFERENCE SIGNS PUT UP

1 COMMUNICATION UNIT
2 STORING UNIT
3 INPUT/OUTPUT INTERFACE UNIT
4 SYSTEM CONTROL UNIT
5 SYSTEM BUS
Tn USER TERMINAL
SA AUCTION PROCESSING SERVER
NW NETWORK

1. A commercial transaction processing device which a terminal device can access through a network, the commercial transaction processing device comprising:
a commercial transaction information storing means that stores commercial transaction information comprising at least one of a number of putting-up of item, a number of bids, a number of successful bids, a number of watchlist registrations and a number of user requests for an item put up for commercial transaction, per item group;
an item information receiving means that receives item information of an item to reserve for commercial transaction, from a terminal device of a reserving seller of the commercial transaction;
an item information storing means that stores the received item information as item information of a reserved item;
a putting-up condition determining means that determines whether or not the reserved item satisfies a predetermined putting-up condition; and
a putting-up processing means that, when the putting-up condition determining means determines that the putting-up condition is satisfied, executes putting-up processing of providing the item information of the reserved item as item information of a put-up item through the network.

2. The commercial transaction processing device according to claim 1,
wherein the putting-up condition determining means determines whether or not at least one of a current number of putting-up of item, a current number of bids, a current number of watchlist registrations and a current number of user requests in an item group to which the reserved item belongs satisfies a predetermined putting-up condition.

3. The commercial transaction processing device according to claim 1,
further comprising a fluctuation range calculating means that calculates a fluctuation range of at least one of a number of putting-up of item, a number of bids, a number of successful bids, a number of watchlist registrations and a number of user requests in an item group to which the reserved item belongs or in an item group related to this item group, in a predetermined period,
wherein the putting-up condition determining means determines whether or not the calculated fluctuation range satisfies a predetermined putting-up condition.

4. The commercial transaction processing device according to claim 2,
wherein the item group is branched into a plurality of groups stepwise from an upper layer to a lower layer,
the item information receiving means receives item group layer information showing a layer specified by the reserving seller or an item group matching the layer, and the item information, and
the putting-up condition determining means determines whether or not at least one of a current number of putting-up of item, a current number of bids, a current number of watchlist registrations and a current number of user requests in the item group matching the layer shown in the received item group layer information satisfies a predetermined putting-up condition.

5. The commercial transaction processing device according to claim 2,
Wherein the item information receiving means receives putting-up condition information showing the putting-up condition specified by the reserving seller, and the item information, and
the putting-up condition determining means determines whether or not at least one of a current number of putting-up of item, a current number of bids, a current number of watchlist registrations and a current number of user requests in an item group to which the reserved item belongs satisfies the putting-up condition shown in the received putting-up condition information.

6. The commercial transaction processing device according to claim 2,
wherein, when the current number of putting-up of item in the item group to which the reserved item belongs is a predetermined value or less, the putting-up condition determining means determines that the putting-up condition is satisfied.

7. The commercial transaction processing device according to claim 2,
wherein, when at least one of the current number of bids, the current number of watchlist registrations and the current number of user requests in the item group to which the reserved item belongs is a predetermined value or more, the putting-up condition determining means determines that the putting-up condition is satisfied.

8. The commercial transaction processing device according to claim 3,
wherein the item group is branched into a plurality of groups stepwise from an upper layer to a lower layer,
the item information receiving means receives item group layer information showing a layer specified by the reserving seller or an item group matching the layer, and the item information, and
the fluctuation range calculating means calculates a fluctuation range of at least one of a number of putting-up of item, a number of bids, a number of successful bids, a number of watchlist registrations and a number of user requests in the item group matching the layer shown in the received item group layer information or in an item group related to the item group, in a predetermined period.

9. The commercial transaction processing device according to claim 3,
wherein the item information receiving means receives putting-up condition information showing the putting-up condition specified by the reserving seller, and the item information, and
the putting-up condition determining means determines whether or not the calculated fluctuation range satisfies the putting-up condition shown in the received putting-up condition information.

10. The commercial transaction processing device according to claim 3,
wherein, when the calculated fluctuation range is a predetermined value or more, the putting-up condition determining means determines that the putting-up condition is satisfied.

11. The commercial transaction processing device according to claim 3,
wherein, when at least one of the number of putting-up of item, the number of bids, the number of successful bids, the number of watchlist registrations and the number of user requests fluctuates in an increase direction, and the calculated fluctuation range is a predetermined value or more, the putting-up condition determining means determines that the putting-up condition is satisfied.

12. The commercial transaction processing device according to claim 3,
wherein, when the number of putting-up of item fluctuates in a decrease direction, and the calculated fluctuation range is a predetermined value or more, the putting-up condition determining means determines that the putting-up condition is satisfied.

13. A putting-up condition determination method executed by a commercial transaction processing device which a terminal device can access through a network,
the putting-up condition determination method comprising:
a step of storing commercial transaction information comprising at least one of a number of putting-up of item, a number of bids, a number of successful bids, a number of watchlist registrations and a number of user requests for an item put up for commercial transaction, per item group;
a step of receiving item information of an item to reserve for commercial transaction, from a terminal device of a reserving seller of the commercial transaction;
a step of storing the received item information as item information of a reserved item;
a step of determining whether or not the reserved item satisfies a predetermined putting-up condition; and
a step of, when determining that the putting-up condition is satisfied, executing putting-up processing of providing the item information of the reserved item as item information of a put-up item through the network.

14-15. (canceled)

16. The commercial transaction processing device according to claim 4,
Wherein the item information receiving means receives putting-up condition information showing the putting-up condition specified by the reserving seller, and the item information, and
the putting-up condition determining means determines whether or not at least one of a current number of putting-up of item, a current number of bids, a current number of watchlist registrations and a current number of user requests in an item group to which the reserved item belongs satisfies the putting-up condition shown in the received putting-up condition information.

17. The commercial transaction processing device according to claim 4,
wherein, when the current number of putting-up of item in the item group to which the reserved item belongs is a predetermined value or less, the putting-up condition determining means determines that the putting-up condition is satisfied.

18. The commercial transaction processing device according to claim 4,
wherein, when at least one of the current number of bids, the current number of watchlist registrations and the current number of user requests in the item group to which the reserved item belongs is a predetermined value or more, the putting-up condition determining means determines that the putting-up condition is satisfied.

19. The commercial transaction processing device according to claim 8,
Wherein the item information receiving means receives putting-up condition information showing the putting-up condition specified by the reserving seller, and the item information, and
the putting-up condition determining means determines whether or not the calculated fluctuation range satisfies the putting-up condition shown in the received putting-up condition information.

20. The commercial transaction processing device according to any one of claim 8,
wherein, when the calculated fluctuation range is a predetermined value or more, the putting-up condition determining means determines that the putting-up condition is satisfied.

21. The commercial transaction processing device according to claim 8,
wherein, when at least one of the number of putting-up of item, the number of bids, the number of successful bids, the number of watchlist registrations and the number of user requests fluctuates in an increase direction, and the calculated fluctuation range is a predetermined value or more, the putting-up condition determining means determines that the putting-up condition is satisfied.

22. The commercial transaction processing device according to claim 8,
wherein, when the number of putting-up of item fluctuates in a decrease direction, and the calculated fluctuation range is a predetermined value or more, the putting-up condition determining means determines that the putting-up condition is satisfied.
